(19) United States
(12) Patent Application Publication
(10) Pub. No.: US 2024/0217279 A1
(43) Pub. Date: Jul. 4, 2024

(54) TIRE AUTO-LOCATION SYSTEMS FOR TIRE PRESSURE MONITOR SENSORS AND OPERATING METHOD THEREOF

(71) Applicant: CHIH-WEI YU, TAIPEI CITY (TW)

(72) Inventor: CHIH-WEI YU, TAIPEI CITY (TW)

(21) Appl. No.: 18/395,629

(22) Filed: Dec. 25, 2023

(30) Foreign Application Priority Data
Dec. 29, 2022 (TW) 111150708

(51) Int. Cl. B60C 23/04

(52) U.S. Cl. CPC B60C 23/0459; B60C 23/0457; B60C 23/0488

(57) ABSTRACT

A tire auto-location system for a tire pressure monitor sensor and operating method thereof are provided. The tire auto-location system for a tire pressure monitor sensor includes a host, a plurality of axle rotation detection devices, and a plurality of tire pressure monitor sensors. By allowing the host to receive and compare the corresponding gear ring rotation data transmitted by the plurality of axle rotation detection devices and the corresponding tire rotation data transmitted by the plurality of tire pressure monitor sensors, the location of each tire pressure monitor sensor can be confirmed. At the same time, since the host and the tire pressure monitor sensor have two-way transmission functions, the host can react quickly and promptly command the tire pressure monitor sensor to stop sensing and transmitting after completing the calculation.

### FIELD OF THE DISCLOSURE

The present disclosure provides a tire pressure monitor sensor tire auto-location system and an operating method thereof.

### BACKGROUND OF THE DISCLOSURE

With the advancement of technology, to allow drivers to be instantly aware of the condition of car tires to prevent sudden tire blowouts or insufficient tire pressure that affect driving safety, many vehicles are currently equipped with tire pressure detection systems. Common tire pressure detection systems include tire pressure detectors disposed on the rims of vehicles and a host receiver inside the vehicle. Each tire pressure detector reads the pressure of the corresponding tire or other preset parameters such as tire temperature, etc. within a certain period, and then transmits the results to the host.

When it comes to tire pressure detection systems, manufacturers on the market often use a programming method to record the corresponding position and serial number of each tire pressure detector on the host to allow the host to identify the tire pressure detectors on different wheels. This is a robust method to configure the system with sensor serial numbers and their vehicular position.

However, although this method is stable, if the tire pressure detector is required to be replaced or the programmed data is wrong, usually it can only be returned to the factory or dealership and reprogrammed, which is extremely troublesome to the user. Therefore, the tire pressure monitor sensor of the wireless locating system is developed in a configuration that allows the host to wirelessly determine the tire location of each tire pressure monitor sensor and brings convenience for users when it comes to replacing tire pressure detectors.

However, the tire pressure monitor sensors on the market have a problem of high-energy consumption, and poor battery life. To enable the host located in the vehicle to accurately locate the tire pressure monitor sensor, the tire pressure monitor sensors usually continuously transmit location data to the host for a long period of time. Consequently the tire pressure monitor sensors remain in a high-energy consumption state, thereby reducing the service life of the tire pressure monitor sensor.

Therefore, the above problem is required to be optimized and improved. Reducing the energy consumption of tire pressure monitor sensors effectively and increasing battery life, which enables the inclusion of other sensor based functions or the use of smaller lighter batteries. Furthermore, the advantages can increase the consumers' desire to purchase tire pressure monitor sensors with the location function.

### SUMMARY OF THE DISCLOSURE

The present disclosure provides a tire auto-location system for a tire pressure monitor sensor and operating method thereof. The tire auto-location system for a tire pressure monitor sensor includes a host, a plurality of axle rotation detection devices, and a plurality of tire pressure monitor sensors. By allowing the host to receive and compare the corresponding gear ring rotation data transmitted by the plurality of axle rotation detection devices and the corresponding tire rotation data transmitted by the plurality of tire pressure monitor sensors, the location of each tire pressure monitor sensor can be confirmed. At the same time, since the host and the tire pressure monitor sensor have two-way transmission functions, the host can react quickly and promptly command the wireless tire pressure sensor to stop sensing and transmitting after completing the calculation. The system and the operating method significantly reduce the power consumption of the tire pressure monitor sensor.

To achieve the above-mentioned objective and effort, the present disclosure provides a tire auto-location system for a tire pressure monitor sensor. The tire auto-location system for a tire pressure monitor sensor includes a host, a plurality of axle rotation detection devices, and a plurality of tire pressure monitor sensors. In which, the host includes a wired transceiver module, a processing computing module, and a wireless duplex transceiver module that are electrically connected to each other, the processing computing module processes the data received from the wired transceiver module and the wireless duplex transceiver module.

Furthermore, the plurality of axle rotation detection devices are disposed on each tire and are wirelessly or electrically connected to the host, and the plurality of axle rotation detection devices include a gear ring and a sensor electrically connected to the gear ring; wherein the sensor continuously transmits the rotation data of the gear ring to the wired transceiver module, so that the location of the axle rotation detection device can be registered in the host;

Moreover, the plurality of tire pressure monitor sensors are disposed on the tires and wirelessly duplex connected with the wireless duplex transceiver module of the host; wherein each tire pressure monitor sensor and each axle rotation detection device are disposed at different locations of the tire; wherein the plurality of tire pressure monitor sensors include a monitoring module, a message module, a control module that are electrically connected to each other, the host commands the control module through the wireless duplex transceiver module, and the control module controls the monitoring module to turn it on or off.

When the monitoring module is on, the monitoring module transmits the tire rotation data to the wireless duplex transceiver module of the host through the message module at a predetermined time or tire rotation angle.

In order to achieve the above-mentioned objective, the present disclosure provides an operating method of a tire auto-location system for a tire pressure monitor sensor, including establishing a wireless connection step, starting to locate step, first data collection step, second data collection step, calculating step, and end locating step. In which, establishing a wireless connection step refers to: a host connects a plurality of axle rotation detection devices and a plurality of tire pressure monitor sensors correspondingly, and the host establishes a duplex wireless connection with the plurality of tire pressure monitor sensors; wherein the axle rotation detection device continuously transmits the rotation data of a corresponding gear ring to a wired transceiver module of the host through a sensor.

Starting to locate step refers to after completing the establishing a wireless connection step, the wired transceiver module of the host transmits a command to a control module of the plurality of tire pressure monitor sensors to turn on a monitoring module.

First data collection step refers to after completing the starting to locate step, the control module turns on the monitoring module, and the monitoring module transmits a first tire rotation data to the wireless duplex transceiver module of the host through a message module at a first predetermined time or first tire rotation angle, and after receiving the first tire rotation data, the host records and reads a rotation data of the plurality of gear rings and set it as a first axle rotation data.

Second data collection step refers to after completing the first data collection step, the monitoring module transmits a second tire rotation data to the wireless duplex transceiver module of the host at a second predetermined time or second tire rotation angle, and after receiving the second tire rotation data, the host records and reads the rotation data of the plurality of gear rings and set it as a second axle rotation data.

Calculating step refers to after completing the second data collection step, the host receives the first tire rotation data and the second tire rotation data from the plurality of tire pressure monitor sensors, and compares and calculates the first axle rotation data and the second axle rotation data through a processing computing module; so that the host calculates the location of each tire pressure monitor sensor corresponding to each axle rotation detection device, and then locates the position of each tire pressure monitor sensor.

End locating step refers to after completing the calculating step, the host has located the position of each tire pressure monitor sensor, and the host transmits a command of turning off the monitoring module to the control module of the tire pressure monitor sensor through the wireless duplex transceiver module, and then the control module receives the command and turns off the monitoring module.

In practice, before the host determines the location of each tire pressure monitor sensor, the host transmits a command to each tire pressure monitor sensor to turn on the monitoring module, and each tire pressure monitor sensor transmits tire rotation data at two specific times or angles (such as the angle of tire rotation at the first and second times, or the time points of tire rotation at the first and second angles). At the same time, after receiving the above data, the host reads the gear ring rotation data (such as angle or time) of the axle rotation detection device, and compares the above data with each other to calculate which tire pressure monitor sensor corresponds to which axle rotation detection device. Further, due to the tire location of each axle rotation detection device being registered by the host in advance (which can be found in the conventional art), the host can calculate and determine the location of each tire pressure monitor sensor.

### BRIEF DESCRIPTION OF THE DRAWINGS

The described embodiments may be better understood by reference to the following description and the accompanying drawings in which:

FIG. 1 is a block schematic diagram of the system of the present disclosure;

FIG. 2 is a framework view of the system of the present disclosure;

FIG. 3 is a schematic view of the system and method of the present disclosure in practice;

FIG. 4 is a schematic view of transmitting data of the present disclosure; and

FIG. 5 is a flowchart of the operating method of the present disclosure.

### DETAILED DESCRIPTION OF THE EXEMPLARY EMBODIMENTS

The present disclosure is more particularly described in the drawings and the following examples are intended to be illustrative only. It is to be understood that these embodiments are exemplary implementations and are not to be construed as limiting the scope of the present disclosure in any way. Further modifications to the disclosed embodiments, as well as other embodiments, are also included within the scope of the appended claims. Regarding the drawings, the relative proportions, and ratios of elements in the drawings may be exaggerated or diminished in size for the sake of clarity and convenience. Such arbitrary proportions are only illustrative and not limiting to the scale.

Unless otherwise defined, all terms used herein, including technical and scientific terms, have the same meanings as commonly understood by those ordinary skilled in the field to which the present disclosure belongs. The use of examples anywhere in this specification including examples of any terms is illustrative only, and in no way limits the scope and meaning of the present disclosure or of any exemplified term. As used in the description herein and throughout the claims that follow, the terms “a”, “an”, “the”, “said” and “at least one”, are used to express the presence of one or more the element/constitute/or the like. The terms “comprise”, “include” and “have” are intended to be inclusive, and mean there may be additional elements/constituents/or the like other than the listed elements/constituents/or the like. Numbering terms such as “first”, “second” or “third” can be used to describe various components, signals, or the like, which are for distinguishing one component/signal from another one only, and are not intended to, nor should be construed to impose any substantive limitations on the components, signals, or the like.

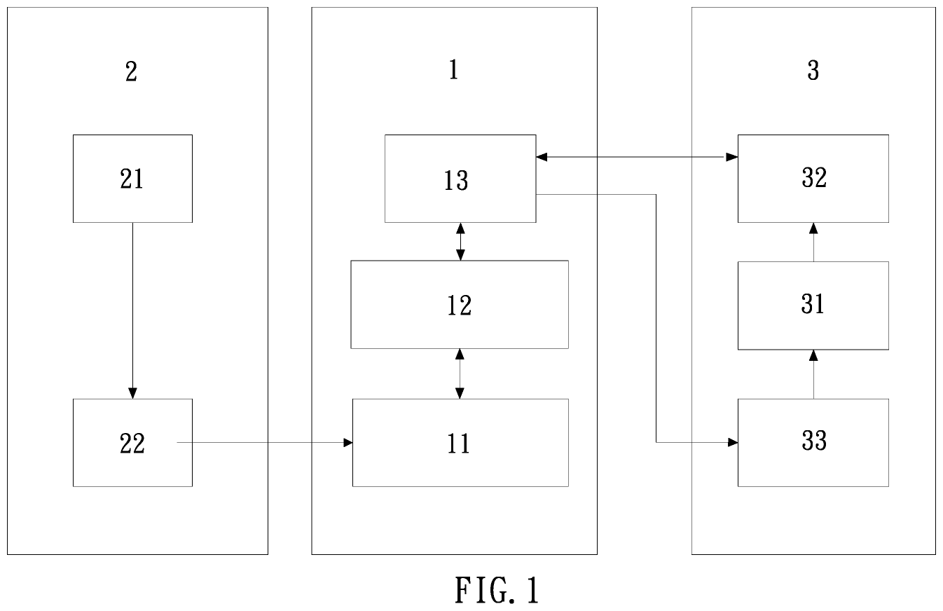

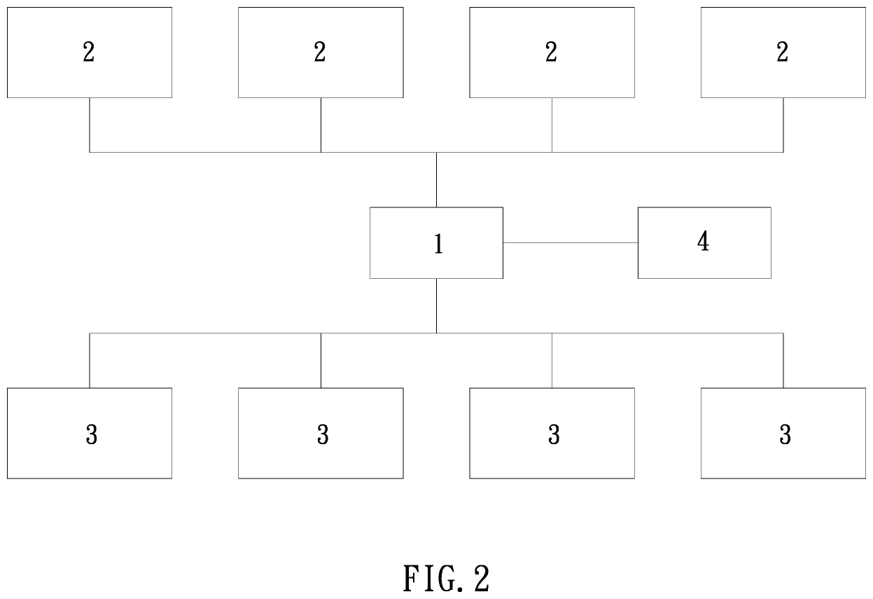

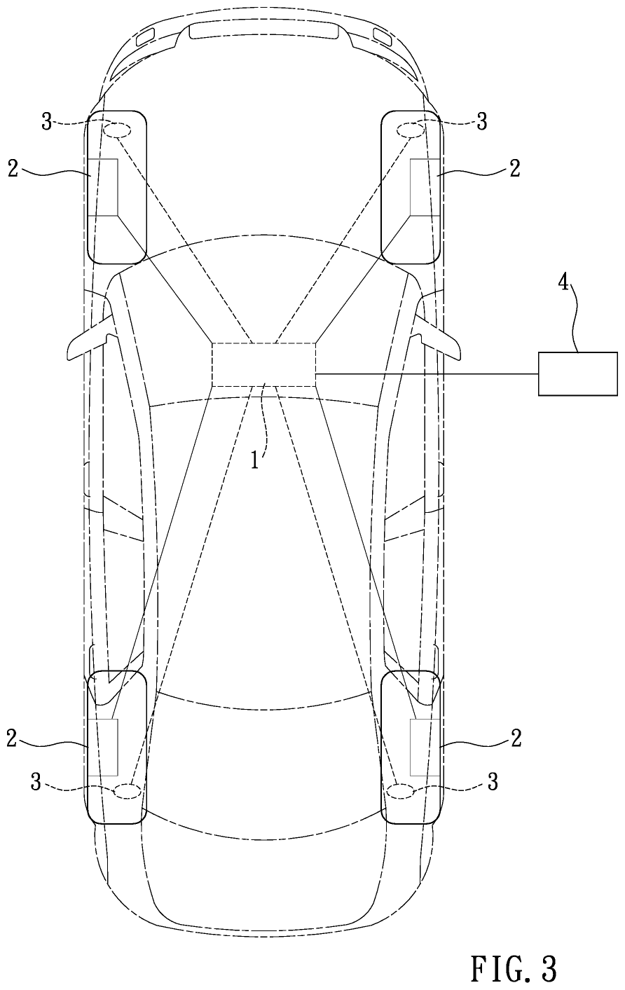

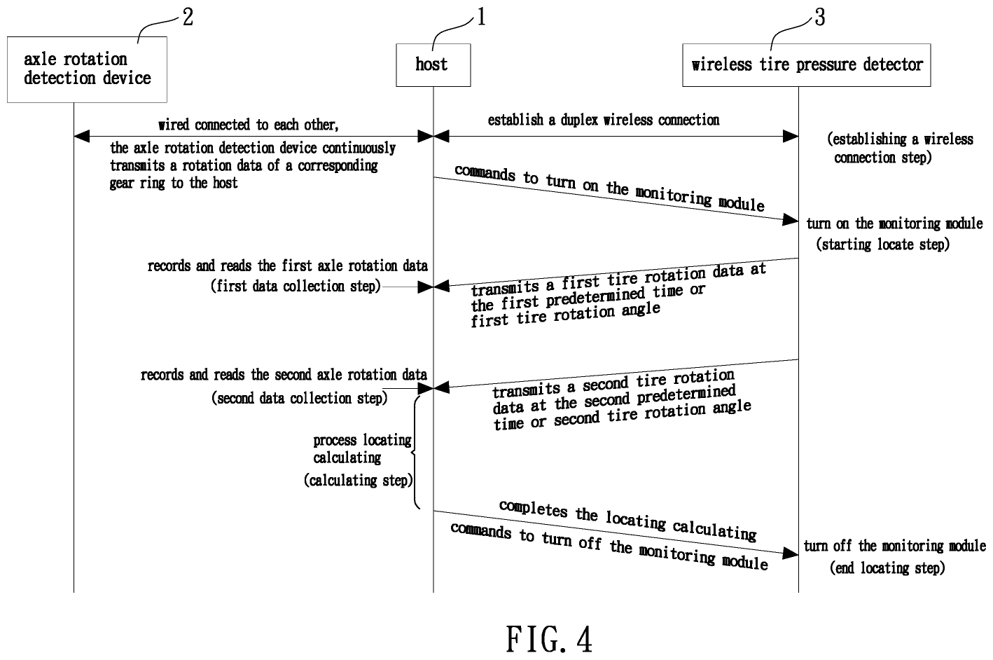

Referring to FIG. 1 to FIG. 4, the present disclosure provides a tire pressure monitor sensor 3 tire auto-location system. The tire auto-location system for a tire pressure monitor sensor includes a host 1, a plurality of axle rotation detection devices 2, and a plurality of tire pressure monitor sensors 3. In which, the host 1 includes a wired transceiver module 11, a processing computing module 12, and a wireless duplex transceiver module 13 that are electrically connected to each other, the processing computing module 12 processes the data received from the wired transceiver module 11, and the wireless duplex transceiver module 13.

Further, the plurality of axle rotation detection devices 2 are disposed on each tire and are wirelessly or electrically connected to the host 1, and the plurality of axle rotation detection devices 2 include a gear ring 21 and a sensor 22 electrically connected to the gear ring 21. In detail, the sensor 22 continuously transmits the rotation data of the gear ring 21, via a communication interface e.g.; CAN transceiver, to the wired transceiver module 11, so that the location of the axle rotation detection device 2 can be registered in the host 1.

Moreover, the plurality of tire pressure monitor sensor 3 is disposed on each tire and wirelessly duplex connected with the wireless duplex transceiver module 13 of the host 1. Each tire pressure monitor sensor 3 and each axle rotation detection device 2 are disposed at different locations of the tire. Further, the plurality of tire pressure monitor sensors 3 include a monitoring module 31, a message module 32, and a control module 33 that are electrically connected to each other, the host 1 commands the control module 33 through the wireless duplex transceiver module 13, and the control module 33 controls the monitoring module 31 to turn on or off.

As shown in FIG. 1 to FIG. 4, when the monitoring module 31 is on, the monitoring module 31 transmits the tire rotation data to the wireless duplex transceiver module 13 of the host 1 through the message module 32 at a predetermined time or tire rotation angle.

In addition, as shown in FIG. 1 to FIG. 4, the tire auto-location system for a tire pressure monitor sensor further includes an external control 4 connected to the host 1, and the external control 4 commands the control module 33 through controlling the host 1.

In certain embodiments, the external control 4 is a host control panel, a wireless control tool, a software application, a wireless OTA (over-the-air programming) device, or a wireless remote-control system.

Although the preferred embodiments are shown and described above, the present disclosure is not limited to the specific embodiments described above, and various modifications and variations can be made by those skilled in the art without departing from the spirit and scope of the appended claims. Therefore, it should be noted that various modifications and variations cannot be considered beyond the technical spirit and scope of the present disclosure.

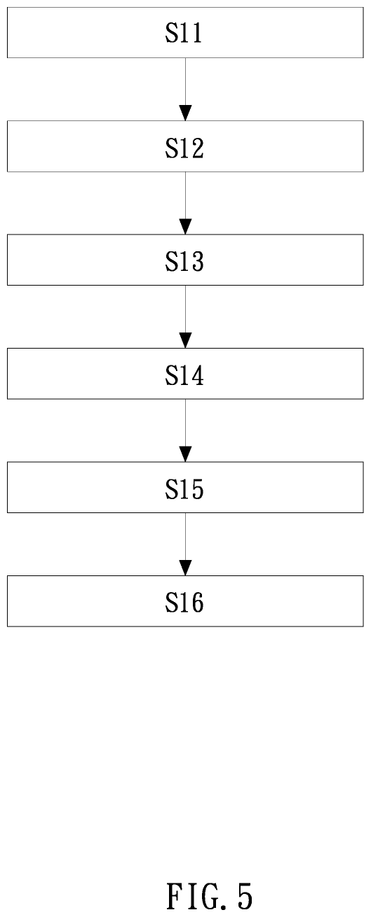

As shown in FIG. 1 to FIG. 5, the present disclosure provides an operating method of a tire auto-location system for a tire pressure monitor sensor, including S11 establishing a wireless connection step, S12 starting to locate step, S13 first data collection step, S14 second data collection step, S15 calculating step and S16 end locating step. Firstly, S11 establishing a wireless connection step: a host 1 connects a plurality of axle rotation detection devices 2 and a plurality of tire pressure monitor sensors 3 correspondingly, and the host 1 establishes a duplex wireless connection with the plurality of tire pressure monitor sensors 3. Furthermore, the axle rotation detection device 2 continuously transmits the rotation data of a corresponding gear ring 21 to a wired transceiver module 11 of the host 1 through a sensor 22.

S12 starting to locate step: after completing the establishing a wireless connection step S11, the wired transceiver module 11 of the host 1 transmits a command to a control module 33 of the plurality of tire pressure monitor sensors 3 to turn on a monitoring module 31.

S13 first data collection step: after completing the S12 starting to locate step, the control module 33 turns on the monitoring module 31, and the monitoring module 31 transmits a first tire rotation data to the wireless duplex transceiver module 13 of the host 1 through a message module 32 at a first predetermined time or first tire rotation angle, and after receiving the first tire rotation data, the host 1 records and reads a rotation data of the plurality of gear rings 21 and set it as a first axle rotation data.

S14 second data collection step: after completing the S13 first data collection step, the monitoring module 31 transmits a second tire rotation data to the wireless duplex transceiver module 13 of the host 1 at a second predetermined time or second tire rotation angle, and after receiving the second tire rotation data, the host 1 records and reads the rotation data of the plurality of gear rings 21 and set it as a second axle rotation data.

S15 calculating step: after completing the S14 second data collection step, the host 1 receives the first tire rotation data and the second tire rotation data from the plurality of tire pressure monitor sensors 3, and compares and calculates the first axle rotation data and the second axle rotation data through a processing computing module 12, so that the host 1 calculates the location of each tire pressure monitor sensor 3 corresponding to each axle rotation detection device 2, and then locates the position of each tire pressure monitor sensor 3.

S16 end locating step: after completing the S15 calculating step, the host 1 has located the position of each tire pressure monitor sensor 3, and the host 1 transmits a command to turn off the monitoring module 31 to the control module 33 of the tire pressure monitor sensor 3 through the wireless duplex transceiver module 13, and then the control module 33 receives the command and turns off the monitoring module 31.

Furthermore, the S12 starting to locate step further includes an external control 4 commanding the control module through controlling the host.

Moreover, the external control 4 is a host control panel, a wireless control tool, a software application, a wireless OTA (over-the-air programming) device or a wireless remote-control system.

In practice, as shown in FIG. 1 to FIG. 5, before the host 1 locates the location of each tire pressure monitor sensor 3, the host 1 transmits a command to each tire pressure monitor sensor 3 to turn on the monitoring module 31, and each tire pressure monitor sensor 3 transmits tire rotation data at two specific times or angles (such as the angle of tire rotation at the first and second times, or the time points of tire rotation at the first and second angles). At the same time, after receiving the above data, the host 1 reads the gear ring 21 rotation data (such as angle or time) of the axle rotation detection device 2, and compares the above data with each other to calculate which tire pressure monitor sensor 3 corresponds to which axle rotation detection device 2. Further, due to the tire location of each axle rotation detection device 2 being registered by the host 1 in advance (which can be found in the conventional art), the host 1 can calculate and locate the location of each tire pressure monitor sensor 3.

What is claimed is:

1. A tire auto-location system for a tire pressure monitor sensor, comprising a host, a plurality of axle rotation detection devices, and a plurality of tire pressure monitor sensors:
wherein the host includes a wired transceiver module, a processing computing module, and a wireless duplex transceiver module that are electrically connected to each other, the processing computing module processes the data received from the wired transceiver module and the wireless duplex transceiver module;
wherein the plurality of axle rotation detection devices are disposed on each tire and are wirelessly or electrically connected to the host, and the plurality of axle rotation detection devices include a gear ring and a sensor electrically connected to the gear ring; wherein the sensor continuously transmits the rotation data of the gear ring to the wired transceiver module, so that the location of the axle rotation detection device can be registered in the host;
wherein the plurality of tire pressure monitor sensor is disposed on each tire and wirelessly duplex connected with the wireless duplex transceiver module of the host; wherein each tire pressure monitor sensor and each axle rotation detection device are disposed at different locations of the tire; wherein the plurality of tire pressure monitor sensors include a monitoring module, a message module, a control module that are electrically connected to each other, the host commands the control module through the wireless duplex transceiver module, and the control module controls the monitoring module to turn on or off;
wherein when the monitoring module is on, the monitoring module transmits the tire rotation data to the wireless duplex transceiver module of the host through the message module at a predetermined time or tire rotation angle.

2. The tire auto-location system for a tire pressure monitor sensor according to claim 1, further including an external control connected to the host, and the external control commands the control module through controlling the host.

3. The tire auto-location system for a tire pressure monitor sensor according to claim 2, wherein the external control is a host control panel, a wireless control tool, a software application, a wireless OTA (over-the-air programming) device or a wireless remote-control system.

4. An operating method of a tire auto-location system for a tire pressure monitor sensor, comprising:
establishing a wireless connection step: a host connecting a plurality of axle rotation detection devices and a plurality of tire pressure monitor sensors correspondingly, and the host establishes a duplex wireless connection with the plurality of tire pressure monitor sensors; wherein the axle rotation detection device continuously transmits the rotation data of a corresponding gear ring to a wired transceiver module of the host through a sensor;
starting to locate step: after completing the establishing a wireless connection step, the wired transceiver module of the host transmits a command to a control module of the plurality of tire pressure monitor sensors to turn on a monitoring module;
first data collection step: after completing the starting to locate step, the control module turns on the monitoring module, and the monitoring module transmits a first tire rotation data to the wireless duplex transceiver module of the host through a message module at a first predetermined time or first tire rotation angle, and after receiving the first tire rotation data, the host records and reads a rotation data of the plurality of gear rings and sets it as a first axle rotation data;
second data collection step: after completing the first data collection step, the monitoring module transmits a second tire rotation data to the wireless duplex transceiver module of the host at a second predetermined time or second tire rotation angle, and after receiving the second tire rotation data, the host records and reads the rotation data of the plurality of gear rings and sets it as a second axle rotation data;
calculating step: after completing the second data collection step, the host receives the first tire rotation data and the second tire rotation data from the plurality of tire pressure monitor sensors, and compares and calculates the first axle rotation data and the second axle rotation data through a processing computing module, so that the host calculates the location of each tire pressure monitor sensor corresponding to each axle rotation detection device, and then locates the position of each tire pressure monitor sensor; and
end locating step: after completing the calculating step, the host has located the position of each tire pressure monitor sensor, and the host transmits a command of turning off the monitoring module to the control module of the tire pressure monitor sensor through the wireless duplex transceiver module, and then the control module receives the command and turns off the monitoring module.

5. The operating method of a tire auto-location system for a tire pressure monitor sensor according to claim 4, wherein the starting to locate step further includes an external control commanding the control module through controlling the host.

6. The operating method of a tire auto-location system for a tire pressure monitor sensor according to claim 5, wherein the external control is a host control panel, a wireless control tool, a software application, a wireless OTA (over-the-air programming) device or a wireless remote-control system.
